(19) United States
(12) Patent Application Publication
(10) Pub. No.: US 2012/0175869 A1
(43) Pub. Date: Jul. 12, 2012

(54) SAFETY COLLAR FOR A PIPE FITTING UNION

(76) Inventor: Paolo Artini, Carmagnola (IT)

(21) Appl. No.: 13/395,707

(22) PCT Filed: Sep. 20, 2010
(86) PCT No.: PCT/IB2010/002338

§ 371 Date: Mar. 13, 2012

(30) Foreign Application Priority Data
Sep. 21, 2009 (IT) TO2009U000134

(51) Int. Cl. F16L 25/00

(52) U.S. Cl. 285/81

(57) ABSTRACT

Safety collar (10) for pipe fitting (T) union (R), in which the said union (R) includes a coupling fastened to a pipe (T) end by means of a nut (D). According to the invention, the said safety collar (10) includes a first and a second brackets substantially U-shaped (10.1, 10.2), which are basically identical and in which the intermediate branch (10.3) of each bracket has a concavity as a circular arc not wider than 180° in a plane substantially orthogonal to the axis of the pipe (T), while each terminal branch (10.4) of each bracket has a through hole (10.6, 10.7) in its base, adjacent to the intermediate branch (10.3), and a tooth (10.5) projecting towards the inside of the \ddot{ν}-shaped bracket at its free end; the holes (10.6) drilled in the said first bracket are threaded, while the holes (10.7) drilled in the said second bracket allow the threaded shank of a respective screw (V) to freely pass through and being screwed into the corresponding threaded hole (10.6) in-the first bracket.

This invention concerns a safety collar for pipe fitting union.

The safety collar for pipe fitting union according to the invention performs anti-disconnection and anti-loosening functions, i.e. it ensures the safe mechanical junction of unions with stiff pipes of different diameters.

The safety collar according to the invention is applicable to hydraulic, oil-pressure and pneumatic systems, in particular to those deployed in the automotive, railway and industrial sectors.

As known, a pipe fitting union includes an externally threaded coupling, at least partially, fastened to a pipe end by means of a correspondingly internally threaded nut. The union is mounted by coaxially inserting the following components on the stiff pipe: a nut, a conical ring (which, being tightened in the nut seat, firmly locks the pipe, thus avoiding its disconnection and ensuring its mechanical sealing), a protection washer and an O-ring. The latter, being compressed by the washer housed in its seat on the coupling mouthpiece, ensures the hermetic sealing. The nut is then tightened on the coupling according to the torque value specified by the manufacturer.

During its use, however, the union is subject to stresses and vibrations which can cause a significant decay of the tightening torque with a consequent risk for the sealing and safety of the union itself.

This invention, by addressing the origin of this problem, aims at solving it.

A purpose of this invention is to implement a safety collar for pipe fitting union ensuring an effective and safe mechanical holding of the union and of its corresponding stiff pipe.

Another purpose of this invention is to implement a safety collar as above specified with a simplified structure, easy and handy to use, with safe operating characteristics and a relatively low cost.

To the said purposes, this invention implements a safety collar for pipe fitting union, whose essential characteristics are the object of claim 1.

Further advantageous characteristics are described in the dependent claims.

The said claims are reported in full herein.

This invention is described in detail hereinafter with reference to the enclosed drawing, supplied just as an example, where:

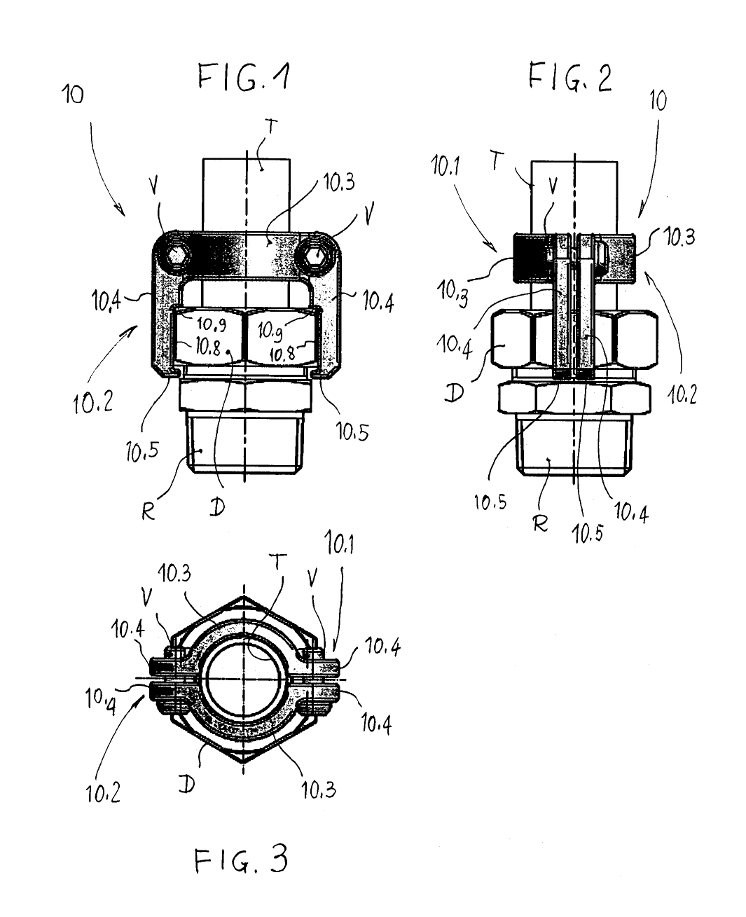

FIGS. 1, 2 and 3 show the safety collar for pipe fitting union according to an embodiment of the invention in front, side and top views, respectively;

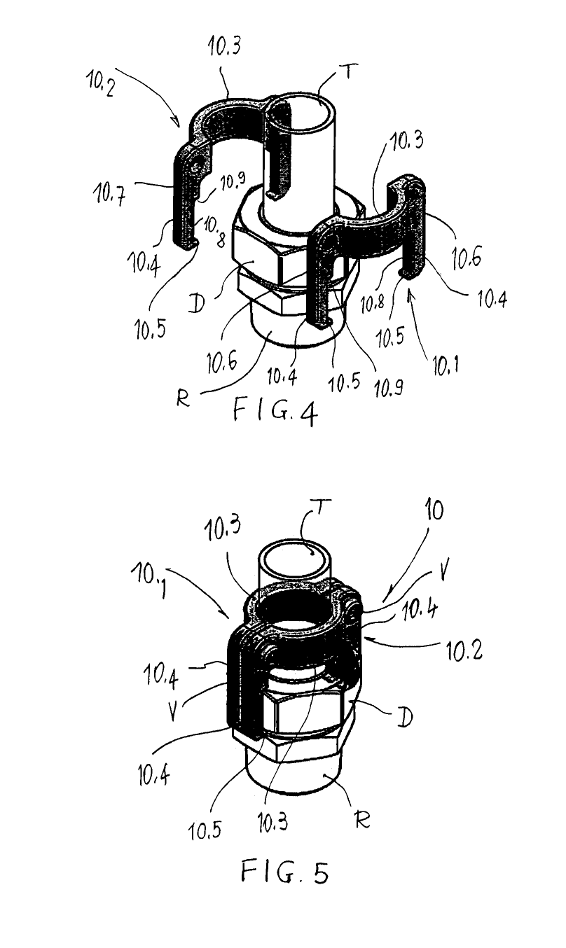

FIG. 4 is a perspective exploded view of the safety collar of FIG. 1, without screws;

FIG. 5 is a perspective view of the safety collar mounted on a pipe fitting union and rotated by 180° with respect to FIG. 4.

Reference 10 in the drawing designates the complete safety collar according to an embodiment of the invention. The safety collar 10 is associated with a union R connected with a stiff pipe T by means of a hexagonal nut D.

The said safety collar 10 includes a first and a second brackets substantially U-shaped, 10.1 and 10.2 respectively, which are basically identical and whose intermediate branch 10.3 has a concavity as a circular arc not wider than 180° in a plane substantially orthogonal to the axis of pipe T (i.e. a plane substantially orthogonal to the terminal branches 10.4).

The two terminal branches of brackets 10.1, 10.2 are referred to as 10.4; each of them has a through hole in its base, which is adjacent to the intermediate branch, and a tooth 10.5 projecting towards the inside of the U shape at its free end.

The said holes drilled in the said first bracket 10.1 are threaded and referred to as 10.6 (FIG. 4), while the holes drilled in the said second bracket 10.2, referred to as 10.7, have a diameter larger than the said holes 10.6 and allow the threaded shank of a respective screw V to freely pass through and being screwed into the corresponding threaded hole 10.6 in the first bracket 10.1.

### Assembling Instructions of the Safety Collar 10.

Place the two brackets 10.1, 10.2 specularly symmetrical with respect to a plane passing through the axis of a pipe T, so letting the end teeth 10.5 of the said terminal branches 10.4 to engage against the lower surface of nut D of union R; insert the shanks of two screws V into the holes 10.7 of the second bracket 10.2 and then screw them into the threaded holes 10.6 of the said first bracket 10.1; finally, tighten the said screws V into the threaded holes 10.6 according to the prescribed torque value, in such a way that the intermediate branches 10.3 of the safety collar 10 clamp the pipe T like a jaw, thus holding nut D of union R, by means of the terminal branches 10.4 terminated with a respective teeth 10.5, in a stable and safe way, so preventing the loosening and disconnection of the union.

In particular, each terminal branch 10.4 has a recess 10.8 facing towards the inside of the bracket, and which is bounded from one side by the said end tooth 10.5 and from the other side by a projection 10.9; this way the said recess 10.8 is juxtaposed with respect to the nut D of union R, thus engaging it at the top by means of the projection 10.9 and at the bottom by the said tooth 10.5.

Each bracket 10.1 can be made as a single piece either of nickel-plated brass, of galvanized steel with white passivation, of stainless steel or of plastic materials, while the two hexagonal-head fastening screws can be made, for example, of galvanized steel.

The coupling diameter of the safety collar may range, as an example, from 4 mm to 8″.

The safety collar 10 according to the invention sensibly reduces the tightening torque decay with time, due to external stresses and vibrations with a considerable increase of the holding effectiveness of union R, so improving its primary safety performances. This results from the improvement of the anchorage between pipe T and union R, ensured by the tightening teeth 10.5 engaged between collar 10 and nut D.

It is important to note that the safety collar 10 can be easily installed not only on new equipment but also on already installed and operating pipe fitting unions (retrofit), so considerably improving their safety. The technical anti-disconnection and anti-loosening characteristics have been suitably tested at growing pressures up to 200 bar and with tightening torque values increasing from 30 Nm up to 300 Nm.

Obviously, many changes can be made in the practice with respect to what here described and illustrated. For example, the shape, the dimensions, the used materials (which metals and metal alloys, plastic materials) of the safety collar according to the invention can widely change to fit the final users' requirements.

1. A safety collar (10) for pipe fitting (T) union (R), in which the said union (R) includes an externally threaded coupling, at least partially, fastened to the pipe (T) end by means of a correspondingly internally threaded nut (D),
the said safety collar (10) comprising a first and a second brackets substantially U-shaped (10.1, 10.2), which are basically identical and in which the intermediate branch (10.3) of each bracket has a concavity as a circular arc not wider than 180° in a plane substantially orthogonal to the axis of the pipe (T), while each terminal branch (10.4) of each bracket has a through hole (10.6, 10.7) in its base, adjacent to the intermediate branch (10.3), and a tooth (10.5) projecting towards the inside of the U-shaped bracket at its free end; the holes (10.6) drilled in the said first bracket being threaded, while the holes (10.7) drilled in the said second bracket allow the threaded shank of a respective screw (V) to freely pass through and being screwed into the corresponding threaded hole (10.6) in the said first bracket (10.1);
wherein, when the said two brackets (10.1, 10.2) are arranged specularly symmetrical with respect to a plane passing through the axis of the pipe (T), so letting the end teeth (10.5) of the said brackets (10.1, 10.2) to engage against the lower surface of nut (D) of the union (R), and the shanks of two screws (V) are then inserted into the respective holes (10.7) of the said second bracket (10.2) and screwed into the threaded holes (10.6) of the said first bracket (10.1) and the said screws (V) are finally tightened into the threaded holes (10.6) according to the prescribed torque value, the intermediate branches (10.3) of the said brackets (10.1, 10.2) clamp the pipe (T) like a jaw, thus holding the nut (D) of the union (R), by means of the terminal branches (10.4) terminated with respective teeth (10.5), in a stable and safe way, so preventing the loosening and disconnection of the union.

2. The safety collar of claim 1, wherein each terminal branch (10.4) of the said brackets (10.1, 10.2) has a recess (10.8) facing towards the inside of the U-shaped bracket and which is bounded from one side by the said end tooth (10.5) and from the other side by a projection (10.9), so that the said recess (10.8) is juxtaposed with respect to the nut (D) of the union (R), thus engaging it at the top by means of the said projection (10.9) and at the bottom by the said tooth (10.5).
